(19) United States
(12) Patent Application Publication
(10) Pub. No.: US 2022/0118418 A1
(43) Pub. Date: Apr. 21, 2022

(54) MANUFACTURING APPARATUS OF CARBIDE

(71) Applicant: NATIONAL TSING HUA UNIVERSITY, Hsinchu (TW)

(72) Inventors: Yu-Lun CHUEH, Hsinchu City (TW); Shu-Chi WU, Tainan City (TW); Yi-Chung WANG, Hsinchu City (TW)

(21) Appl. No.: 17/204,964

(22) Filed: Mar. 18, 2021

(30) Foreign Application Priority Data
Oct. 16, 2020 (TW) 109213672

(51) Int. Cl. B01J 19/08; B01J 19/02; B01J 19/00; C01B 32/914; C01B 32/97; C01B 32/921

(52) U.S. Cl. CPC B01J 19/088; B01J 19/02; B01J 19/0013; C01B 32/914; C01B 32/97; C01B 32/921; C01P 2002/82; B01J 2219/0263; B01J 2219/0811; B01J 2219/0841; B01J 2219/0877; B01J 2219/0871; C01P 2002/72; B01J 2219/00099

(57) ABSTRACT

A manufacturing apparatus of carbide of the present disclosure includes a tank, a lid, a molten salt crucible, an electrode assembly, an air intake device and a heating device. The lid is connected to the tank to jointly delimit a compartment. The molten salt crucible is disposed in the compartment for containing a salt. The electrode assembly includes a working electrode and a counter electrode. An end of the working electrode and an end of the counter electrode both contact the salt in the molten salt crucible, and the end of the working electrode contacting the salt is for fixing a reactant tablet. The air intake device is configured to exchange the air in the compartment. The heating device is configured to heat the compartment.

### RELATED APPLICATIONS

This application claims priority to Taiwan Application Serial Number 109213672, filed Oct. 16, 2020, which is herein incorporated by reference.

### BACKGROUND

### Technical Field

The present disclosure relates to a molten salt electrochemical apparatus. More particularly, the present disclosure relates to a molten salt electrochemical apparatus for manufacturing carbides.

### Description of Related Art

Amorphous carbon is a kind of carbon with relatively low crystallinity. Amorphous carbon includes lots of functional groups consisting of hydrogen, oxygen and nitrogen atoms, which forms the irregular crystalline structure of amorphous carbon. It is possible for the structure of amorphous carbon to regularly rearrange by applying high temperature to the amorphous carbon, and the amorphous carbon will turn into graphite with high crystallinity. The abovementioned process is called graphitization.

According to the structural difference, the amorphous carbon can be divided into soft carbon, which is easy to be graphitized, and hard carbon, which is difficult to be graphitized. The crystalline arrangement of soft carbon is more similar to graphite. Petroleum coke, coke and carbon fibers all belong to soft carbon. The crystalline arrangement of hard carbon is more chaotic than soft carbon, and the reactivity of hard carbon is lower than soft carbon. Carbonized polymers, charcoal, carbon black, carbohydrates and plant fibers are common hard carbon.

For example, for the graphitization of soft carbon or hard carbon, the soft carbon should be heated at a temperature over 2500° C. for 48-120 hours to form graphite, and the hard carbon is difficult to become graphite even in a high temperature environment over 2500° C. Thus, it could be understood that the reaction conditions of amorphous carbon are severe. It needs lots of energy and time to process the amorphous carbon, which not only increases the processing cost, but also consumes plenty of environmental resources.

In this regard, it is still an unsolved problem to graphitize or modify the amorphous carbon under simple reaction conditions.

### SUMMARY

According to an embodiment of the present disclosure, a manufacturing apparatus of carbide includes a tank, a lid, a molten salt crucible, an electrode assembly, an air intake device and a heating device. The lid is detachably connected to the tank, and a compartment is jointly delimited by the lid and the tank. The molten salt crucible is disposed in the compartment and configured to contain a salt in a molten state. The electrode assembly extends into the compartment from the outside. The electrode assembly includes a working electrode and a counter electrode, and an end of the working electrode and an end of the counter electrode are both disposed in the molten salt crucible, so as to contact the salt in the molten salt crucible. The air intake device communicates with the compartment, so as to exchange an air in the compartment. The heating device surrounds an outer surface of the tank, so as to heat the tank and make a temperature of the compartment increase. The end of the working electrode in the molten salt crucible is for fixing a reactant tablet, so as to make the reactant tablet contact the salt and react with the salt to form a carbide.

### BRIEF DESCRIPTION OF THE DRAWINGS

The present disclosure can be more fully understood by reading the following detailed description of the embodiment, with reference made to the accompanying drawings as follows:

FIG. 1 is a cross-sectional schematic view of a manufacturing apparatus of carbide according to an embodiment of the present disclosure.

FIG. 2 is an X-ray diffraction pattern of the products of Example 1 and Example 2.

FIG. 3 is an X-ray diffraction pattern of the products of Example 3 and Example 4.

FIG. 4 is a Raman spectrum of the product of Example 5.

### DETAILED DESCRIPTION

The embodiment of the present disclosure will be described below with reference to the drawings. For clear explanation, many practical details will also be explained in the following description. However, it should be understood that these practical details should not be the limitation of the present disclosure. Furthermore, in order to simplify the drawings, some conventional structures and elements will be illustrated in the drawings by a simple and schematic way.

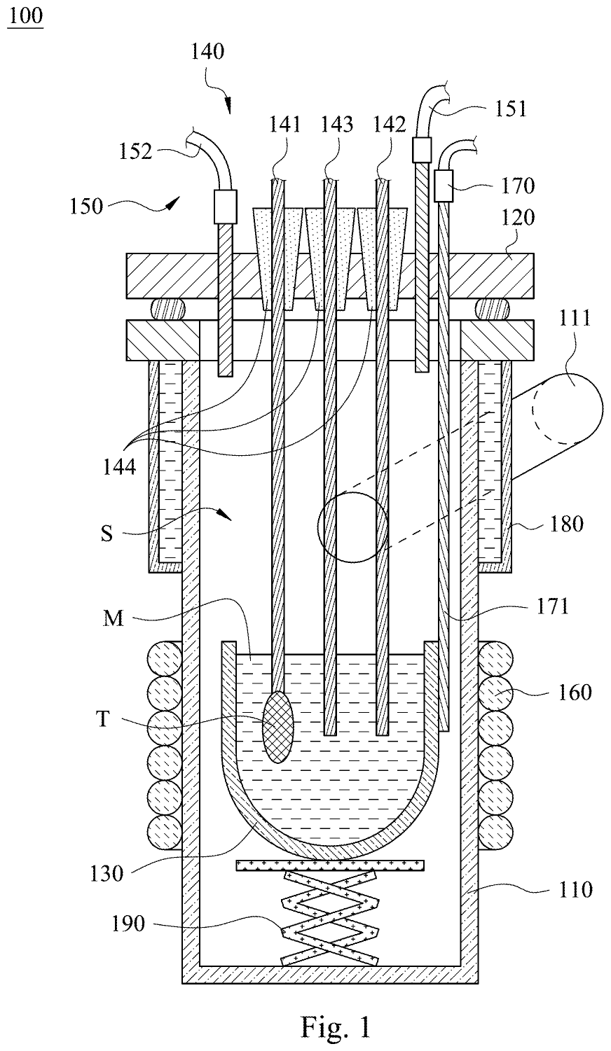

Please refer to FIG. 1. FIG. 1 is a cross-sectional schematic view of a manufacturing apparatus of carbide 100 according to an embodiment of the present disclosure. The manufacturing apparatus of carbide 100 includes a tank 110, a lid 120, a molten salt crucible 130, an electrode assembly 140, an air intake device 150 and a heating device 160.

Because the manufacturing process of carbide needs to be performed under high temperature, the tank 110 is preferably made of metal. A composite layer of stainless steel-titanium material (not shown) can be disposed on an inner side of the tank 110, so as to prevent the corrosion of the tank 110 caused by high temperature and ensure the structural strength of the tank 110. There can be an observing window 111 arranged on the tank 110. Users can safely observe the tank 110 from outside during the high temperature process, and the safety and convenience when using the manufacturing apparatus of carbide 100 can be enhanced.

The lid 120 is detachably connected to the tank 110, and a compartment S is jointly delimited by the lid 120 and the tank 110 for arranging other components.

The molten salt crucible 130 is disposed in the compartment S and configured to contain a salt M. The salt M will be heated to its molten state in the manufacturing process of carbide, and the molten salt crucible 130 can be made of aluminum oxide. The chemical stability of aluminum oxide is high, and aluminum oxide has good corrosion resistance to the molten salt M and the durability of the molten salt crucible 130 can be enhanced.

The electrode assembly 140 extends into the compartment S from the outside, so as to perform an electrochemical reaction in the compartment S. In details, the electrode assembly 140 includes a working electrode 141 and a counter electrode 142. An end of the working electrode 141 and an end of the counter electrode 142 are both disposed in the molten salt crucible 130, so as to contact the salt M in the molten salt crucible 130. The end of the working electrode 141 in the molten salt crucible 130 is for fixing a reactant tablet T. In this regard, the reactant tablet T can contact the salt M to perform the electrochemical reaction and form a carbide. The manufacturing process will be further explained in the following paragraphs, and unnecessary details will not be given here. The working electrode 141 can be made of molybdenum or tungsten, and the counter electrode 142 can be made of graphite or SnO₂. The abovementioned materials provide good conductivity to the electrodes and prevent the electrodes from reacting.

The electrode assembly 140 can be a two-electrode system or a three-electrode system, that is, the electrode assembly 140 can further include a reference electrode 143. An end of the reference electrode 143 is also disposed in the molten salt crucible 130, so as to contact the salt M in the molten salt crucible 130. The reference electrode 143 can be taken as the standard for measuring the potential, and the potential of the working electrode 141 and the counter electrode 142 can be precisely measured.

The electrode assembly 140 can further include at least two airtight members 144. The airtight members 144 are disposed on the lid 120, and the working electrode 141 and the counter electrode 142 slidably extend through two of the airtight members 144, respectively. When the manufacturing process is over, users can pull the working electrode 141 and the counter electrode 142 from the molten salt crucible 130 without opening the lid 120, which prevents the electrodes stuck in and being difficult to detach from the crystalline salt M after the salt M cools down. The airtight members 144 can prevent the hot air escape as pulling the electrodes, so as to enhance the safety of users operating the manufacturing apparatus of carbide 100.

The air intake device 150 communicates with the compartment S, so as to exchange an air in the compartment S for a noble gas with low reactivity under high temperature. In this regard, it prevents the reactant from reacting with the air in the compartment S, and the efficiency of manufacturing the carbide is enhanced. For example, the air intake device 150 can include an air inlet 151 and an air outlet 152, and both the air inlet 151 and the air outlet 152 communicates with the compartment S for gases entering or leaving the compartment S, which is not a limitation to the present disclosure.

The heating device 160 surrounds an outer surface of the tank 110. For example, the heating device 160 can be a heating pipe surrounds outside of the tank 110. Thus, the tank 110 can be evenly heated and a temperature of the compartment S can be increased.

The manufacturing apparatus of carbide 100 can further include a thermocouple 170. The thermocouple 170 includes a detecting end 171 attached to an outer side of the molten salt crucible 130, so as to precisely measure the temperature of the molten salt crucible 130. Users can determine the heating condition of the salt M in the molten salt crucible 130 by observing from the observing window 111 and measuring temperature using the thermocouple 170. Therefore, the state of the salt M can be more easily and precisely determined.

The manufacturing apparatus of carbide 100 can further include a cooling water tank 180, and the cooling water tank 180 surrounds the outer surface of the tank 110 adjacent to the lid 120. The cooling water tank 180 can prevent the gas in the compartment S from overheat, and the cooling water tank 180 facilitates the gas cooling down after the process is over. Thus, the temperature in the compartment S can be effectively controlled.

The manufacturing apparatus of carbide 100 can further include a lifting device 190. The lifting device 190 is disposed in the compartment S to control the molten salt crucible 130 moving in a vertical direction. The lifting device 190 can be a lifting equipment such as a jack, which will not be limited in the present disclosure. One side of the lifting device 190 can be connected to an inner bottom surface of the tank 110, and the other side of the lifting device 190 can be connected to an outer bottom surface of the molten salt crucible 130, so as to lift the molten salt crucible 130 up from the bottom of the tank 110 to the opening. It helps users adjust the position of the molten salt crucible 130 to coordinate with the electrode assembly 140 or change the salt M in the molten salt crucible 130.

The manufacturing apparatus of carbide 100 of the present disclosure is for the reactant tablet T reacting with the molten salt M to form the carbide. In details, the reactant tablet T can include an amorphous carbon and a compound of a metal or a metalloid, and the salt M can be an alkaline earth metal halide. The molten alkaline earth metal halide can react with the amorphous carbon and turn the amorphous carbon into graphite microcrystal. The graphite microcrystal will further react with the compound to form the carbide containing the metal or the metalloid.

In the following, the electrochemical reactions of different kinds of materials are performed in the manufacturing apparatus of carbide 100 of the present disclosure. X-ray diffraction analysis or Raman spectroscopic analysis of the manufactured products is performed, so as to determine the chemical compositions of the products. The materials used in each of the examples and the ratios of the materials in the reactant tablets T are listed in Table 1.

TABLE 1
Types and Ratios of Materials Used in Example 1-Example 5

| | | Ratio of | Ratio of |
|---|---|---|---|
| | Type of | Compound | Amorphous |
| | Compound | (wt. %) | Carbon (wt. %) |
| Example 1 | Iron Oxide | 20 | 80 |
| Example 2 | | 30 | 70 |
| Example 3 | Silicon Dioxide | 50 | 50 |
| Example 4 | | 80 | 20 |
| Example 5 | Titanium Oxide | 50 | 50 |

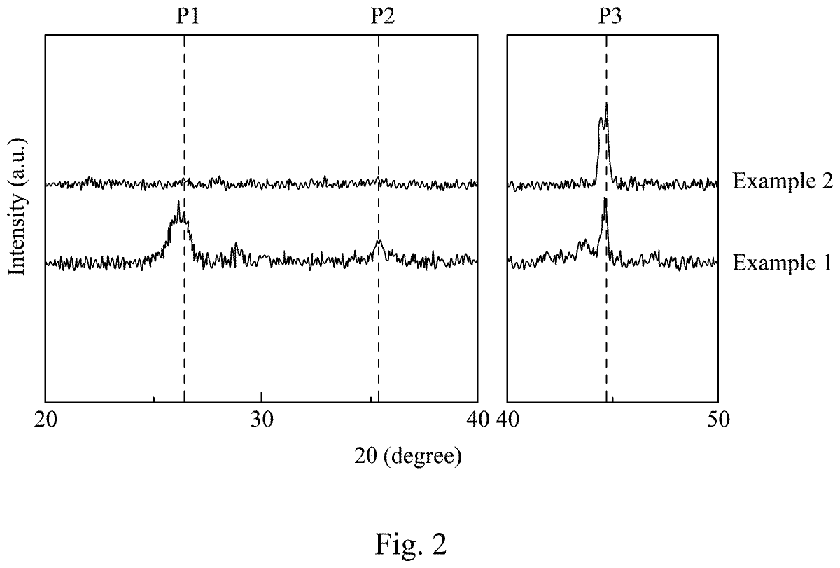

Please refer to FIG. 2. FIG. 2 is an X-ray diffraction pattern of the products of Example 1 and Example 2. In FIG. 2, the compositions of the products can be determined from characteristic peaks P1, P2, P3. The characteristic peak P1 corresponds to graphite, the characteristic peak P2 corresponds to iron oxide, and the characteristic peak P3 corresponds to iron carbide. From FIG. 2, it is proved that the products of Example 1 and Example 2 both include iron carbide, because the X-ray diffraction results of Example 1 and Example 2 both show the significant characteristic peak P3. Moreover, there is the characteristic peak P1 in the X-ray diffraction result of Example 1, which means that the product of Example 1 further includes graphite. By the manufacturing apparatus of carbide of the present disclosure, not only the carbides can be manufactured, but also the graphite can be synthesized from the amorphous carbon with specific ratios of the materials.

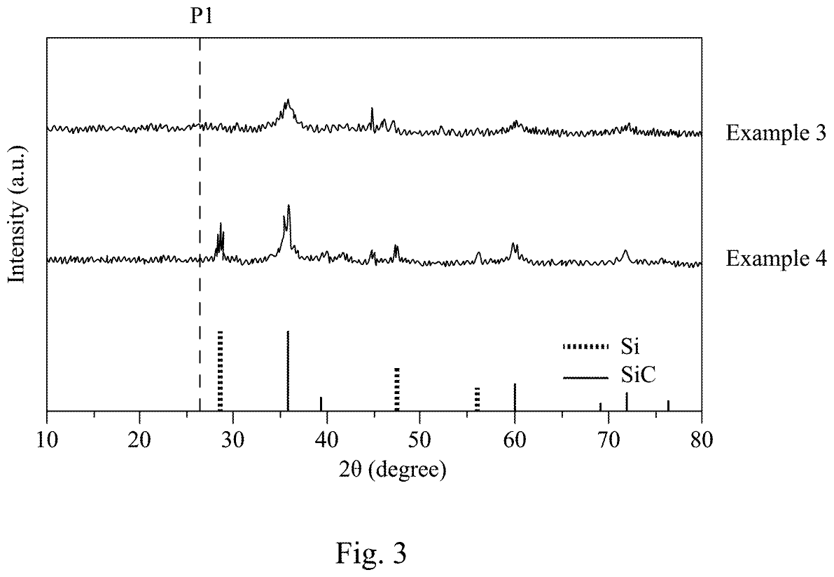

Please refer to FIG. 3. FIG. 3 is an X-ray diffraction pattern of the products of Example 3 and Example 4. In FIG. 3, the characteristic peak P1 corresponds to graphite, dotted lines below Example 4 correspond to characteristic peak values of silicon, and solid lines below Example 4 correspond to characteristic peak values of silicon carbide. From FIG. 3, it can be understood that the product of Example 3 includes silicon carbide, and that the product of Example 4 includes silicon and silicon carbide. By the manufacturing apparatus of carbide of the present disclosure, not only the carbides can be manufactured, but also the compounds can be reduced into the metal or the metalloid with specific ratios of the materials.

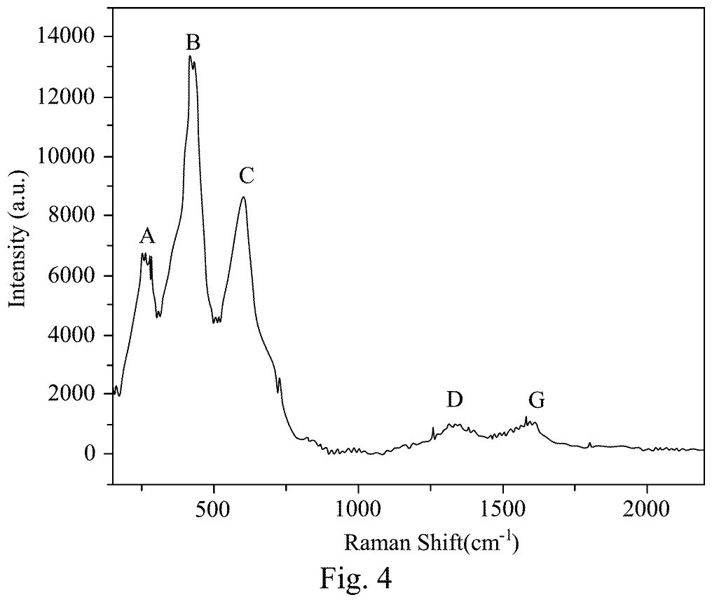

Please refer to FIG. 4. FIG. 4 is a Raman spectrum of the product of Example 5. Peaks A, B, C, D and G can be read in FIG. 4. The peaks A, B and C correspond to titanium carbide, the peak D corresponds to the amorphous carbon, and the peak G corresponds to graphite. The peaks A, B and C have higher intensity than the peaks D and G, which means the titanium oxide can successfully react with the amorphous carbon, and great amount of titanium carbide is formed by the manufacturing apparatus of carbide of the present disclosure.

In this regard, the manufacturing apparatus of the present disclosure is for the reactant tablet with amorphous carbon and the molten salt undergo the electrochemical reaction, so as to form the carbides. Therefore, the reaction temperature and time of the amorphous carbon can be reduced, the complexity of the manufacturing process is decreased, and the consumption of energy and manufacturing costs are significantly saved.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A manufacturing apparatus of carbide, comprising:
a tank;
a lid detachably connected to the tank, wherein a compartment is jointly delimited by the lid and the tank;
a molten salt crucible disposed in the compartment and configured to contain a salt in a molten state;
an electrode assembly extending into the compartment from the outside, and comprising:
a working electrode; and
a counter electrode;
wherein an end of the working electrode and an end of the counter electrode are both disposed in the molten salt crucible, so as to contact the salt in the molten salt crucible;
an air intake device communicating with the compartment, so as to exchange an air in the compartment; and
a heating device surrounding an outer surface of the tank, so as to heat the tank and make a temperature of the compartment increase;
wherein the end of the working electrode in the molten salt crucible is for fixing a reactant tablet, so as to make the reactant tablet contact the salt and react with the salt to form a carbide.

2. The manufacturing apparatus of carbide of claim 1, wherein the tank comprises a composite layer of stainless steel-titanium material on an inner side of the tank.

3. The manufacturing apparatus of carbide of claim 1, wherein the molten salt crucible is made of aluminum oxide.

4. The manufacturing apparatus of carbide of claim 1, wherein the working electrode is made of molybdenum or tungsten.

5. The manufacturing apparatus of carbide of claim 1, wherein the counter electrode is made of graphite or SnO₂.

6. The manufacturing apparatus of carbide of claim 1, wherein the electrode assembly further comprises a reference electrode, an end of the reference electrode is disposed in the molten salt crucible, so as to contact the salt in the molten salt crucible.

7. The manufacturing apparatus of carbide of claim 1, wherein the electrode assembly further comprises at least two airtight members, the at least two airtight members are disposed on the lid, and the working electrode and the counter electrode slidably extend through two of the airtight members, respectively.

8. The manufacturing apparatus of carbide of claim 1, further comprising a thermocouple, the thermocouple comprises a detecting end attached to an outer side of the molten salt crucible.

9. The manufacturing apparatus of carbide of claim 1, further comprising an observing window arranged on the tank for observing the salt in the molten salt crucible.

10. The manufacturing apparatus of carbide of claim 1, further comprising a cooling water tank surrounding the outer surface of the tank adjacent to the lid.

11. The manufacturing apparatus of carbide of claim 1, further comprising a lifting device disposed in the compartment, wherein one side of the lifting device is connected to an inner bottom surface of the tank, the other side of the lifting device is connected to an outer bottom surface of the molten salt crucible, and the lifting device is configured to control the molten salt crucible moving in a vertical direction.
